(19) United States
(12) Patent Application Publication
(10) Pub. No.: US 2025/0314789 A1
(43) Pub. Date: Oct. 9, 2025

(54) INTERNAL IMAGING AND MODEL CONSTRUCTION

(71) Applicant: Equinor Energy AS, Stavanger (NO)

(72) Inventor: Steen Agerlin PETERSEN, Bergen (NO)

(73) Assignee: Equinor Energy AS, Stavanger (NO)

(21) Appl. No.: 18/881,652

(22) PCT Filed: Jun. 22, 2023
(86) PCT No.: PCT/NO2023/050150

§ 371 Date: Jan. 6, 2025

(30) Foreign Application Priority Data
Jul. 5, 2022 (GB) 2209830.5

(51) Int. Cl. G01V 1/28; G01V 1/30; G06T 19/20

(52) U.S. Cl. CPC G01V 1/282; G01V 1/302; G01V 1/306; G06T 19/20; G01V 2210/6226; G06T 2219/2016

(57) ABSTRACT

A method of obtaining a three-dimensional model of a current sub-surface formation. The method comprises obtaining three-dimensional, treated, physical survey data, and comprising measurement data at each of a multiplicity of indexed locations within a regular three-dimensional grid of indexed locations. For a given set of geological processes, a backward sequence of corresponding inverse geological processes is obtained which, when the backward sequence is applied to the treated physical survey data, transform that treated physical survey data into representative survey data which is approximately representative of the sub-surface formation at a time of its formation. A three-dimensional model of the sub-surface formation is derived at a time of its formation, the model comprising one or more material properties at each of said indexed locations, and said set of geological processes is applied to the derived three-dimensional model, in a forward sequence to obtain a current model of the sub-surface formation. Each of the geological processes and their inverses is defined as a linear or rotational shift, or combination of such shifts, of the measurement data or material properties between the indexed locations.

### TECHNICAL FIELD

The present invention relates to internal imaging and model construction for near real-time applications. It is applicable in particular, though not necessarily, to internal imaging of subsurface formations of the Earth and model construction of the same.

### BACKGROUND

In many technical fields it is desirable to construct models that accurately represents properties and dimensions of internal, i.e. hidden, formations, using data collected by probing the formations with some form of energy, for example seismic energy, electromagnetic (EM) energy or X-rays, or passively via potential fields such as gravity and magnetic fields The constructed models essentially provide an image of the formation using no, or only limited, direct inspection of the interior of the formation. The construction can be challenging in a computational sense assuming that relatively high resolution and accuracy are required.

In the case of investigation of potential resources in the subsurface of the earth (e.g. oil or gas), their exploitation and/or injection of material (e.g. related to carbon capture and storage, CCS), it is extremely important to have an idea and some knowledge of the subsurface formation in order to be able to locate suitable reservoirs, manage drilling processes, and efficiently manage extraction or injection. In this field a typical model construction process involves performing a seismic survey by emitting seismic energy into the formation and reading the seismic response of the subsurface at selected receiver positions. Starting with a likely model of the formation, e.g. provided by geologists and geophysicists, a model optimization process is commonly used to iteratively adjust the likely model in small steps until a model is constructed that provides a similar seismic response to the recordings of the real Earth experiment.

Two major classes of modelling construction techniques exist today: geometry-based and geology-based. Both construction techniques can be considered in a process-oriented scheme; a geometry-based approach relies on combining geometrical objects only to form a subsurface model obeying the observations, whereas a geology-based approach seeks to reconstruct a subsurface combining a set of geological processes, emulating the geological evolution in space and time. Due to the use of geological oriented processes, models based on reconstruction, rather than on geometrical construction, become geologically realistic reflecting precisely the impact of structural, depositional, erosional as well as diagenetic processes.

Geologically reconstructed models are preferable due to the provided realism, but leave the builder with two essential questions: 1) which geologically processes must be invoked and 2) in what order? Costs of reconstruction, in addition, also play a role in selecting the methodology for model construction. Geological (forward) processes executed in a three-dimensional volume can be extremely costly in time and computational effort.

The above questions are addressed to a large extent by an approach such as that described in “Process-based data-restoration and model-reconstruction workflow for simultaneous seismic interpretation and model building”, Steen Agerlin Petersen et al, 74th EAGE Conference & Exhibition incorporating SPE EUROPEC 2012 Copenhagen, Denmark, 4-7 Jun. 2012. FIG. 1 illustrates the approach at a general level in the context of a process that may be used to construct a model of a subsurface region of the Earth using data obtained from a seismic survey. Since surface seismic data (or “image”) is the primary source of information on the subsurface, processes controlling the construction of the final model are identified from the seismic image and its interpretation. A vertical 2D slice of a 3D seismic image is shown in the top left panel (A) of FIG. 1, where the vertical axis denotes depth, the horizontal axis denotes a horizontal direction, and intensity denotes reflection strength. Whilst various structures (reflectors) can be seen in the image, these are complex and in particular the reservoir interval(s) appear complex and subtle.

A sequence of restoration operations is performed on the seismic image to reduce its complexity and essentially restore the image to one corresponding to an earlier geological time, typically to the time at which the layers were first laid down. This involves identifying and applying a sequence of inverse geological processes (i.e. representing processes going backwards in geological time) to the image including, for example, inverse processes corresponding to; deposition, erosion, deformation and transformation of the subsurface properties via diagenesis. This might be in the form of a trial-and-error approach, guided by likely inverse processes and their sequence. The restoration operation is terminated when the reservoir intervals appear approximately horizontal. The restored image is shown in the top right panel (B) of FIG. 1. We can now establish a sequence of defined process steps (each going forward in geological time) describing changes undergone by the formation to arrive at its present state. It will be appreciated that it is much more straightforward to recognise an acceptable final reconstructed seismic image (by seeking to achieve generally horizontal layers) than it is to recognise a complex model as is required in the solely forward process-builder approach.

The bottom right panel (C) of FIG. 1 shows a model of what we expect the formation to have looked like at the time of its formation. Again, the vertical axis denotes depth and the horizontal axis represents the (same) horizontal direction, whilst intensity denotes acoustic impedance. This model is typically provided by geologists using their knowledge and experience, an analysis of the restored seismic image (B), and taking into account other survey information, e.g. core and log data. We then apply the determined processes (i.e. the forward equivalents of the previously identified inverse processes), taken in reverse order, to the starting model (C) to arrive at a model which aims to provide a realistic model (in terms of acoustic impedance) of the formation of interest in its current state. This is illustrated in the bottom left panel (D) of FIG. 1.

In a typical use scenario, the approach illustrated in FIG. 1 may be used to construct a model of elastic properties such as compressional and shear velocities as well as formation densities, using the results of a seismic survey, for a sub-surface region of the Earth during an exploration of that region for hydrocarbons or prior to commencing drilling operations. During drilling, a further survey may be conducted downhole covering a region close to the well, e.g. using some surveying equipment at or close to the drill bit. This survey is then used to enhance the model in the surveyed region, again using a process-based data-restoration and model-reconstruction workflow.

Matrix algebra operations for implementing the various geological processes and their inverses have been identified and verifiedEach process or inverse process involves performing a coordinate transform on the source data and, significantly, an interpolation on the transformed data in order to “re-grid” that data back to the source grid. Running a full process sequence for construction and/or editing of 3D models, even for a relatively small region around a drill bit, is time consuming (e.g. in the order of hours or more), mainly due to the heavy calculation required by the structural and partly depositional processes. In particular, the re-gridding of scattered 3D information to a regular 3D grid representation, effectively prevents working with real-time models especially if the number of grid points is large, e.g. approaching 10\hat{ }9. Whilst this may be acceptable before or after drilling, e.g. in exploration or production evaluation, it is not acceptable in managing critical decisions in near real-time, for example during drilling.

### SUMMARY

According to a first aspect of the present invention there is provided a method of obtaining a three-dimensional model of a current sub-surface formation of the Earth. The method comprises obtaining three-dimensional, treated, physical survey data, in respect of said current subsurface formation, and comprising measurement data at each of a multiplicity of indexed locations within a regular three-dimensional grid of indexed locations. For a given set of geological processes, a backward sequence of corresponding inverse geological processes is obtained which, when the backward sequence is applied to the treated physical survey data, transform that treated physical survey data into representative survey data which is approximately representative of the sub-surface formation at a time of its formation. A three-dimensional model of the sub-surface formation is derived at a time of its formation, based on said representative survey data, the model comprising one or more material properties at each of said indexed locations, and said set of geological processes applied to the derived three-dimensional model, in a forward sequence that is the reverse of said backward sequence, to obtain a current model of the sub-surface formation. Each of the geological processes and their inverses is defined as a linear or rotational shift, or combination of such shifts, of the measurement data or material properties between the indexed locations or a sub-set of the indexed locations.

The term “shift” is considered to encompass both re-indexing of measurement data or material properties along or around an axis, as well as the elastic compression or extension of the data along or around the axis. A linear shift may be one of a vertical shift or a horizontal shift.

The treated physical survey data may comprise data obtained using a seismic survey and said measurement data, at each indexed location, is, or is indicative of, seismic reflectance at the indexed location. The material properties may include acoustic impedance.

The geological processes may include one or more deformation processes, for example extensional faulting, collapsing, injection, compression, and extension.

The treated physical survey data may be obtained by way of a physical survey performed from a surface of the Earth above the sub-surface formation, or a location above that surface, e.g. from within or on a body of water above the surface.

The treated physical survey data may be obtained by way of a physical survey performed downhole within a well extending into or though the sub-surface formation and the sub-surface formation comprises a region surrounding at least a portion of the well.

According to a second aspect of the present invention there is provided a method of geo-steering a drill bit whilst drilling a well into a sub-surface formation, the method comprising implementing the method of the above first aspect of the invention, where the treated physical survey data is obtained by way of a physical survey performed downhole within a well extending into or though the sub-surface formation and the sub-surface formation comprises a region surrounding at least a portion of the well. and utilising the obtained current model to make a steering decision.

A method according to the above first aspect of the invention and comprising performing a physical survey to obtain said three-dimensional physical survey data.

A method according to the above first aspect of the invention and comprising rendering the obtained current model and displaying the rendered model on a display of a computer device.

### BRIEF DESCRIPTION OF THE DRAWINGS

FIG. 1 illustrates a known geological-based approach to constructing a model of a sub-surface region of the Earth;

FIG. 2 illustrates the application of exemplary linear actuators to introduce geological processes into a sub-surface model;

FIG. 3 illustrates the use of a pair of linear actuators to perform fault restoration and reconstruction of a seismic image;

FIG. 4 further illustrates restoration and reconstruction operations according to an embodiment; and FIG. 5 is a flow diagram illustrating steps in the restoration and reconstruction operations.

### DETAILED DESCRIPTION

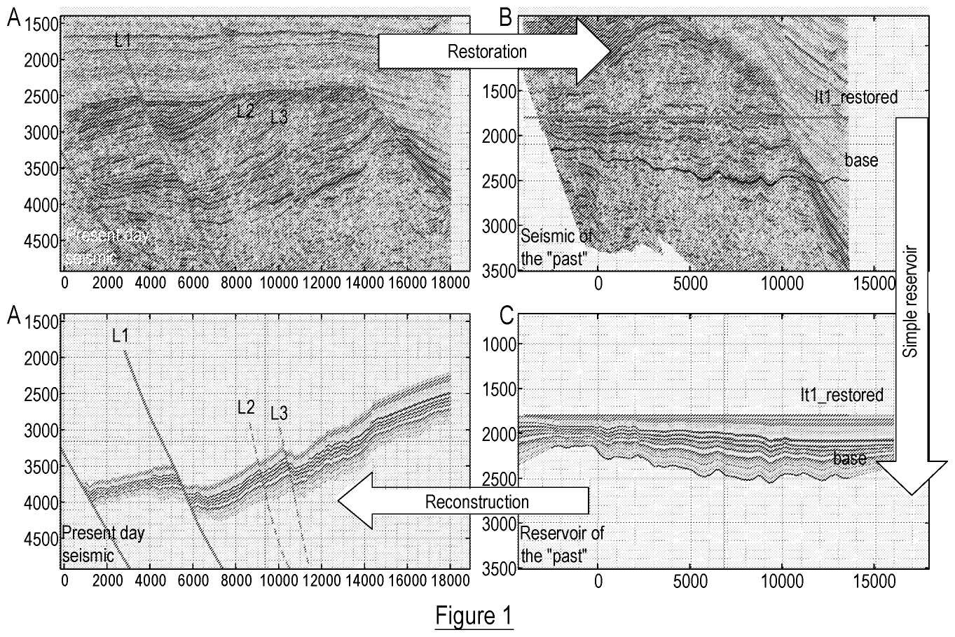

As has been noted above, a problem with the implementation of Geologically reconstructed models, as illustrated in FIG. 1, is the high computational cost of applying identified processes and their inverses in both the backward, restoration operation, and the forward, reconstruction operation, particularly when it comes to returning that adapted data to the original grid (re-gridding). The solutions presented here flow from a recognition that the various processes and inverse processes applied by the known process-based data-restoration and model-reconstruction workflow (illustrated in FIG. 1) can be individually represented by respective simple processes, or a combination of such simple processes, controlling elements of the structural movements of the formation layers. These simple processes can be executed extremely quickly. The strategy is in some ways analogous to how complex motions in robotics are described (as a sequence of “movement primitives”). The movement primitives include 1D linear actuators (for pulling and/or pushing material) and rotary actuators with one to three rotational axes. By way of example, and in the interest of computational efficiency, the 1D linear actuators may operate primarily along Cartesian axes. Operations along other directions may require shift and rotation of the components to align direction of Cartesian system. The combination of primitives has demonstrated high potential towards fast modelling of volume deformation, like extensional faulting, collapsing, injection, compression, extension etc.

The proposed solutions make it possible to create and change 3D models, and hence property distributions, e.g. in the vicinity of wellbores (e.g. distances up to 200 m or more) within a few minutes, acceptable in a real-time context. The size and quality of the models makes them suitable to explain nearly all scales of surface and wellbore data from surface seismic data down to borehole logs with very short Distance-of-Investigation (DoI of, e.g. Gamma Ray logs). The produced models can therefore be an important component in the decision processes during drilling. Indeed, embodiments of the invention may be integrated into a drilling operation service including steering and otherwise operating the drill bit using observations and analysis of the obtained models.

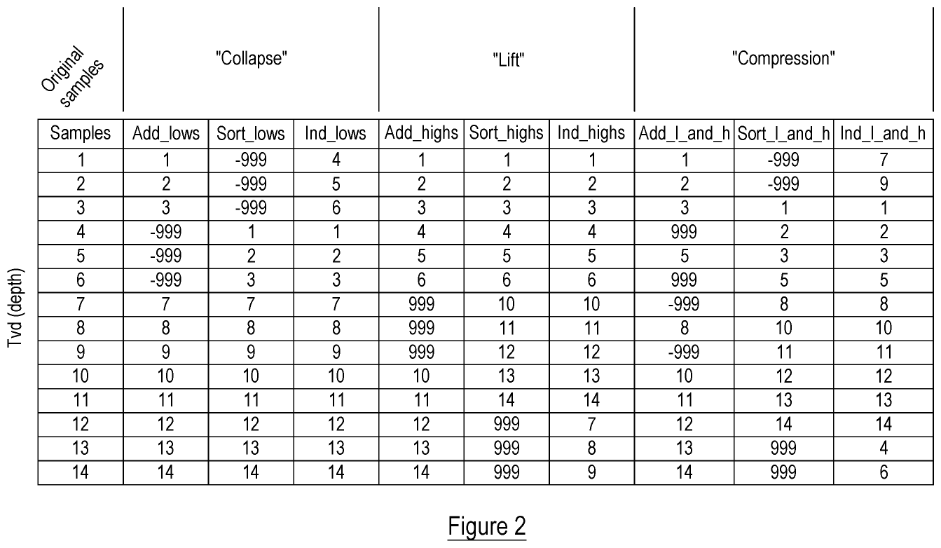

FIG. 2 is helpful in understanding this approach to representing complex geological processes with simple processes by way of 1D linear actuators. It illustrates the operation of 1D linear actuators on a 1D column of sample points on a regular grid (i.e. with regular physical spacing between grid positions). Of course, a 3D model will be composed of a 2D array of these 1D columns. The “samples” column indicates the depth of a particular sample point (by way of respective depth indices, 1,2,3 . . . etc) of the model, where each point has an associated model parameter or parameters (not shown), e.g. acoustic impedance. In the sample column, the sample points are in depth order. In order to introduce a “collapse” process into the model column, we replace the depth indices of those sample points that disappear in the collapse with some very low depth index, in this example “−999”). This is shown in the column headed “Add_lows”. We then perform a sorting operation to reorder the indices from low to high. The reordered result is shown in the column headed “Sort_lows”. We retain the original (reordered) indices in the column headed “Ind_lows”. Similar operations can be performed to introduce “lift” and “compression” processes into the 1D column as illustrated in the Figure. It will be appreciated that, by retaining the original (reordered) indices it is possible to quickly and efficiently return the columns to their original state, i.e. to reverse the applied process.

It will be readily appreciated that the use of 1D linear actuators does not in any way alter the regularity of the (original) grid. Model parameters are merely shifted from one grid point to another. No re-gridding, and associated interpolation, is required. The term “shift” here may encompass an elastic compression or extension of the values in a linear direction (or a rotational direction). In the case of an elastic compression, this may involve removal of indexed locations. In the case of extension, indexed locations and associated data may be added, e.g. using simple interpolation.

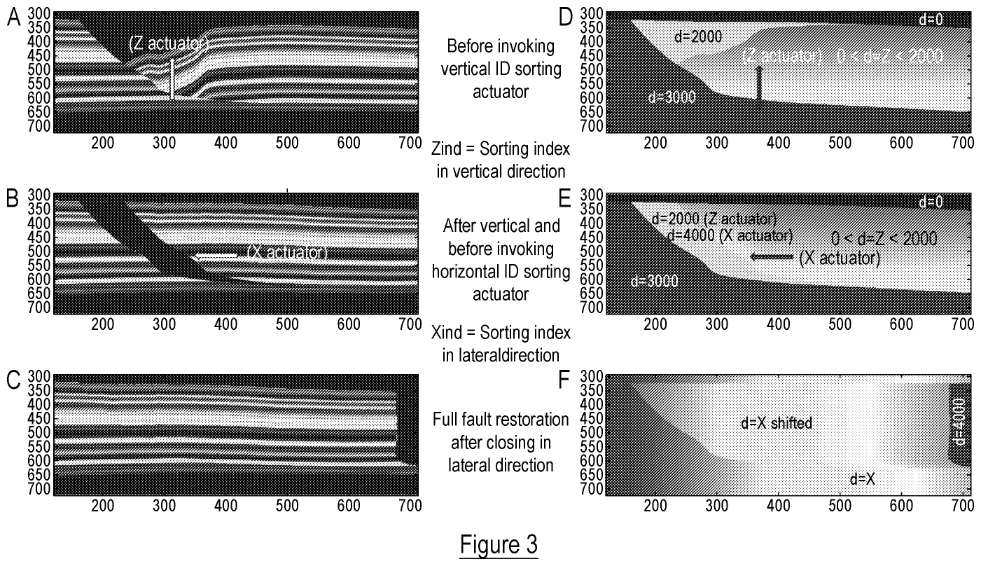

FIG. 3 illustrates the use of a pair of linear 1D actuators to perform fault restoration and reconstruction of a seismic image. The uppermost view (A) in the left hand sequence shows the original seismic image obtained from a seismic survey. A pair of linear actuators [a first operating vertically (B) and a second operating horizontally (C)] are used to remove a fault from the image and essentially align the various distinct layers. This particular selection of linear actuators, including their extent(s), is arrived at by a trial and error process, guided for example, with certain geological knowledge and/or constraints. We know, or can surmise, that the correct selection and ordering of linear actuators has been made by considering the final alignment of the layers in the image.

The right hand sequence in FIG. 3 illustrates the adjustments that are made to the indices of the geological model to implement the two determined actuators or rather their inverses, where that geological model (D) is arrived at by an analysis of the restored seismic image, expert knowledge, and possibly other data. (E) illustrates the model after application of the vertical 1D operator whilst (F) illustrates the model after application of the horizontal 1D operator. Sorting in the vertical direction is achieved using vertical depth indices as the primary information and by adding large indices (2000) above the hanging wall and even larger indices (3000) within the foot wall. Retaining the original indices within the overburden keep this in place.

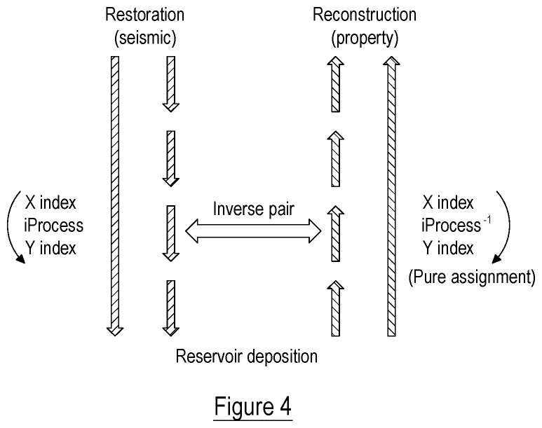

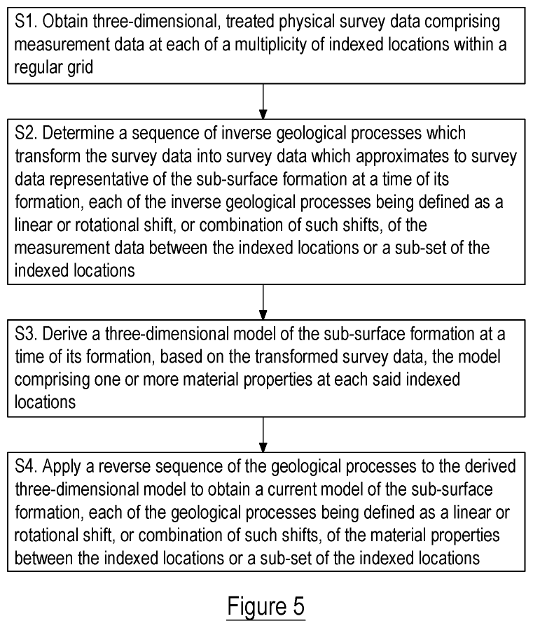

The restoration (on the seismic image) and reconstruction (on the model properties) sequences are further illustrated in FIG. 4, where the term “iProcess” is used to indicate the individual actuators that are identified and applied (in sequence), in the 2D (X,Y) or 3D space.

The process of FIG. 3 determines the translation of indices (in two directions) to restore and remove the fault. The reconstruction process is applied to the formation model (e.g. a model of elastic properties and densities) that is considered to correspond to the formation at the time of its original establishment taking into account the restored seismic image. It will be appreciated that, computationally, this process can be carried out quickly and at very low computational expense as all we are doing is moving the formation properties to the position corresponding to the position provided by the translated indices estimated during restoration, thus avoiding re-gridding and the associated interpolation. Indeed, the reconstruction process is ideally suited to low level CPU processes and fast, low level implementations (C, assembler) can be identified and used to control the actuators. The application of Floats and Doubles can be avoided, and instead use made of Booleans, NaNs, Infs, uint16's as input to the actuators. Similarly, navigation within the regular cubes is integer/index based meaning that the actuators operate in a discrete space.

FIG. 5 is a flow diagram further illustrating the restoration and reconstruction operations of the described method, consistent with the present invention.

The methods described above can be implemented on known computer systems including systems implementing cloud computing services. These systems will include configurations of processors, memory, display terminals, networks connections and the like.

1. A method of obtaining a three-dimensional model of a current sub-surface formation of the Earth and comprising:
obtaining three-dimensional, treated, physical survey data, in respect of said current subsurface formation, and comprising measurement data at each of a multiplicity of indexed locations within a regular three-dimensional grid of indexed locations;
for a given set of geological processes, determining a backward sequence of corresponding inverse geological processes which, when the backward sequence is applied to the treated physical survey data, transform that treated physical survey data into representative survey data which is approximately representative of the sub-surface formation at a time of its formation;
deriving a three-dimensional model of the sub-surface formation at a time of its formation, based on said representative survey data, the model comprising one or more material properties at each of said indexed locations; and
applying said set of geological processes to the derived three-dimensional model, in a forward sequence that is the reverse of said backward sequence, to obtain a current model of the sub-surface formation,
wherein
each of the geological processes and their inverses is defined as a linear or rotational shift, or combination of such shifts, of the measurement data or material properties between the indexed locations or a sub-set of the indexed locations.

2. The method according to claim 1, wherein said treated physical survey data comprises data obtained using a seismic survey and said measurement data, at each indexed location, is, or is indicative of, seismic reflectance at the indexed location.

3. The method according to claim 2, wherein said material properties include acoustic impedance.

4. The method according to claim 1, wherein said geological processes include one or more deformation processes, for example extensional faulting, collapsing, injection, compression, and extension.

5. The method according to claim 1, a linear shift being one of a vertical shift or a horizontal shift.

6. The method according to claim 1, wherein said treated physical survey data is obtained by way of a physical survey performed from a surface of the Earth above the sub-surface formation, or a location above that surface, e.g. from within or on a body of water above the surface.

7. The method according to claim 1, wherein said treated physical survey data is obtained by way of a physical survey performed downhole within a well extending into or though the sub-surface formation and the sub-surface formation comprises a region surrounding at least a portion of the well.

8. A method of geo-steering a drill bit whilst drilling a well into a sub-surface formation, the method comprising implementing the method of claim 7 and utilising the obtained current model to make a steering decision.

9. The method according to claim 1 and comprising performing a physical survey to obtain said three-dimensional physical survey data.

10. The method according to claim 1 and comprising rendering the obtained current model and displaying the rendered model on a display of a computer device.
